(19) United States
(12) Patent Application Publication
(10) Pub. No.: US 2002/0166913 A1
(43) Pub. Date: Nov. 14, 2002

(54) Data storage tape cartridge with tape reel assembly centering feature

(75) Inventors: Peter A. Ridl, St. Paul, MN (US); G. Phillip Rambosek, Shafer, MN (US)

Correspondence Address: Attention: Eric D. Levinson, Imation Corp., Legal Affairs, P.O. Box 64898, St. Paul, MN, 55164-0898, US

(73) Assignee: Imation Corp.

(21) Appl. No.: 09/852,252

(22) Filed: May 9, 2001

(51) Int. Cl. G11B 15/32; G11B 23/027

(52) U.S. Cl. 242/340; 242/348; 242/355.1

(57) ABSTRACT

A data storage tape cartridge including a housing, a tape reel assembly, a brake assembly, a centering device, and a storage tape. The tape reel assembly includes a hub, opposing top and bottom flanges, and drive teeth. The drive teeth extend in an axial fashion relative to the hub and are provided for engagement by a tape drive chuck. The centering device is provided to support the tape reel assembly in a centered position relative to the tape reel opening in the locked state. The centering device includes a rib and a corresponding groove. The rib is formed by one of the bottom flange and the base, whereas the groove is formed by another of the bottom flange and the base. The groove is configured to selectively receive the rib, thereby supporting the tape reel assembly in the center position. The centering device prevents the tape reel assembly from laterally shifting relative to the tape reel opening when the data storage tape cartridge is vertically oriented.

### BACKGROUND OF THE INVENTION

The present invention relates to a data storage tape cartridge. More particularly, it relates to a data storage tape cartridge configured to support a tape reel assembly in a center position relative to an opening formed by a housing when the tape reel assembly is in a locked state.

Data storage tape cartridges have been used for decades in the computer, audio, and video fields. The data storage tape cartridge continues to be an extremely popular form of recording large volumes of information for subsequent retrieval and use.

A data storage tape cartridge generally consists of an outer shell or housing maintaining at least one tape reel assembly and a length of magnetic storage tape. The storage tape is wrapped about a hub portion of the tape reel assembly and is driven through a defined tape path by a driving system. The housing normally includes a separate cover and base, the combination of which forms an opening (or window) at a forward portion thereof for allowing access to the storage tape by a read/write head upon insertion of the data storage tape cartridge into a tape drive. This interaction between storage tape and head may take place within the housing (for example, with a mid-tape load design), or the storage tape may be directed away from the housing to an adjacent area at which the read/write head is located (for example, with a helical drive design or a leader block design). Where the tape cartridge/drive system is designed to direct the storage tape away from the housing, a single tape reel assembly is normally employed. Conversely, where the tape cartridge/drive system is configured to provide head/storage tape interaction within or very near the housing, a two- or dual-tape reel assembly configuration is typically utilized.

Regardless of the number of tape reel assemblies associated with a particular data storage tape cartridge, the tape reel assembly itself is generally comprised of three basic components; namely, an upper flange, a lower flange, and a hub body. The hub body forms an outer, tape-winding surface about which the storage tape is wound. The flanges are disposed at opposite ends of the hub, and are spaced to approximate the height of storage tape. Finally, the tape reel assembly forms drive teeth that are engaged by corresponding teeth of a drive chuck for rotating the tape reel assembly upon insertion into a tape drive.

Upon final assembly, the tape reel assembly is generally aligned with a circular tape reel opening formed through the housing (typically in the base section). This tape reel opening is sized to allow interaction between the tape drive chuck and the drive teeth associated with the tape reel assembly. When the data storage tape cartridge is not in use, the tape reel assembly is typically “locked” or otherwise prevented from undesirably rotating. To this end, a brake assembly is provided for each tape reel assembly. The brake assembly can assume a wide variety of forms, such as multiple brake bodies biased to selectively engage an outer circumference of the tape reel assembly. A more common, less expensive approach includes a single brake body and a spring disposed within a central bore of the tape reel assembly. The brake body is slidably associated with a protrusion or post formed by the housing cover opposite the tape reel opening. Further, the spring biases the brake body into engagement with the tape reel assembly, such that the brake body rigidly connects the tape reel assembly with the cover via the post. For example, the brake body can form a toothed surface configured to engage interior brake teeth formed by the tape reel assembly. In this locked position, then, the tape reel assembly is “locked” to the housing cover, and thus will not rotate.

The above-described brake assembly has proven to be highly effective in preventing tape reel rotation when the data storage tape cartridge is not in use. However, the brake assembly only generally aligns the tape reel assembly relative to a center axis of the tape reel opening. Manufacturing tolerances associated with the various cartridge components inherently allows the tape reel assembly to laterally move or shift within the housing. This potential concern is exacerbated when the cartridge is maneuvered from a horizontal orientation. For example, handling and/or storage of the cartridge commonly requires that the cartridge be turned on its side (i.e., vertically oriented). As part of this movement, or when vertically oriented for an extended period of time, the tape reel assembly may laterally move or shift within the housing such that the tape reel assembly is no longer aligned with the tape reel opening. In the event of a relatively substantial lateral shift, the tape drive chuck may experience difficulties in engaging the drive teeth of the tape reel assembly during subsequent use.

More recent data storage tape cartridge designs have attempted to solve the above-described centering concern by forming a chamfered edge in the housing base at the tape reel opening. The bottom flange associated with the tape reel assembly includes an angled protrusion that contacts the chamfered edge in the locked position, in theory centering the tape reel assembly relative to the tape reel opening. Unfortunately, product specifications limit the allowable spring force provided by the brake assembly spring. As such, the angled protrusion associated with the bottom flange readily slides or slips along the chamfered edge. Thus, the tape reel assembly will still transversely or lateral move or shift when the cartridge is vertically oriented.

Data storage tape cartridges are important tools used to maintain vast amounts of information. As the cartridge and drive components continue to evolve, alignment deviations, such as alignment of the tape reel assembly relative to the tape reel opening in the housing, are less tolerable. Therefore, a need exists for a data storage tape cartridge configured to prevent transverse movement of the tape reel assembly in a locked state.

### SUMMARY OF THE INVENTION

One aspect of the present invention relates to a data storage tape cartridge including a housing, a tape reel assembly, a brake assembly, a centering device, and a storage tape. The housing includes a base and a cover that combine to define an enclosed space. The base forms a tape reel opening. The tape reel assembly includes a hub, opposing top and bottom flanges, and drive teeth. The hub defines a tape-winding surface. The opposing top and bottom flanges extend radially from opposite ends of the hub, respectively. The drive teeth extend in an axial fashion relative to the hub and are provided for engagement by a tape drive chuck. The tape reel assembly is rotatably disposed within the housing such that the drive teeth are accessible through the tape reel opening. The brake assembly includes a spring biasing a brake body to a locked state in which the brake body impedes rotation of the tape reel assembly. The centering device is provided to support the tape reel assembly in a centered position relative to the tape reel opening in the locked state. With this in mind, the centering device includes a rib and a corresponding groove. The rib is formed by one of the bottom flange and the base, whereas the groove is formed by an other of the bottom flange and the base. In this regard, the groove is configured to selectively receive the rib, thereby supporting the tape reel assembly in the center position. Finally, the storage tape is wound about the tape-winding surface. In one preferred embodiment, the bottom flange forms the rib and the base forms the groove. Alternatively, the rib is formed by the base and the groove is formed by the bottom flange. Regardless, the centering device prevents the tape reel assembly from laterally shifting relative to the tape reel opening when the data storage tape cartridge is vertically oriented.

Another aspect of the present invention relates to a tape reel assembly for use with a data storage tape cartridge. The tape reel assembly includes a hub, drive teeth, brake teeth, an upper flange and a lower flange. The hub defines a tape-winding surface, a top end and a bottom end. The drive teeth extend axially outwardly relative to the bottom end of the hub. The upper flange extends radially from the top end of the hub. The lower flange, on the other hand, extends radially from the bottom end of the hub. In this regard, the lower flange defines an outer surface and an inner surface, and forms a centering feature. The centering feature is radially spaced from the drive teeth and the brake teeth. In one preferred embodiment, the centering feature is a rib. In an alternative embodiment, the centering feature is a groove.

Yet another aspect of the present invention relates to a method of supporting a tape reel assembly in a center position relative to a tape reel opening in a housing of a data storage tape cartridge. The method includes providing the tape reel assembly with a first centering feature. Also, the housing is provided with a second centering feature. The second centering feature is formed at an interior of the housing about, and spaced from, the tape reel opening. In this regard, one of the first and second centering features is a rib and another of the centering features is a corresponding groove. The tape reel assembly is biased to a locked state in which the first centering feature engages the second centering feature. With this method, upon movement of the data storage tape cartridge from a horizontal orientation, the centering feature prevents lateral displacement of the tape reel assembly relative to the tape reel opening in the locked state.

### BRIEF DESCRIPTION OF THE DRAWINGS

FIG. 1 is an exploded, perspective view of a data storage tape cartridge in accordance with the present invention;

FIG. 2A is a perspective view of a bottom flange portion of a tape reel assembly in accordance with the first embodiment of the present invention;

FIG. 2B is a perspective view of a base portion in accordance with a first embodiment of the present invention;

FIG. 3A is a cross-sectional view of a first embodiment data storage tape cartridge incorporating the components of FIGS. 3A and 3B in an unlocked state;

FIG. 3B is a cross-sectional view of the data storage tape cartridge of FIG. 3A in a locked state;

FIG. 4A is a perspective view of a bottom flange portion of the tape reel assembly in accordance with a second embodiment of the present invention;

FIG. 4B is a perspective view of a base in accordance with the second embodiment of the present invention;

FIG. 5A is a cross-sectional view of a second embodiment data storage tape cartridge incorporating the components of FIGS. 4A and 4B in an unlocked state; and

FIG. 5B is a cross-sectional view of the data storage tape cartridge of FIG. 5A in a locked state.

### DETAILED DESCRIPTION OF THE PREFERRED EMBODIMENTS

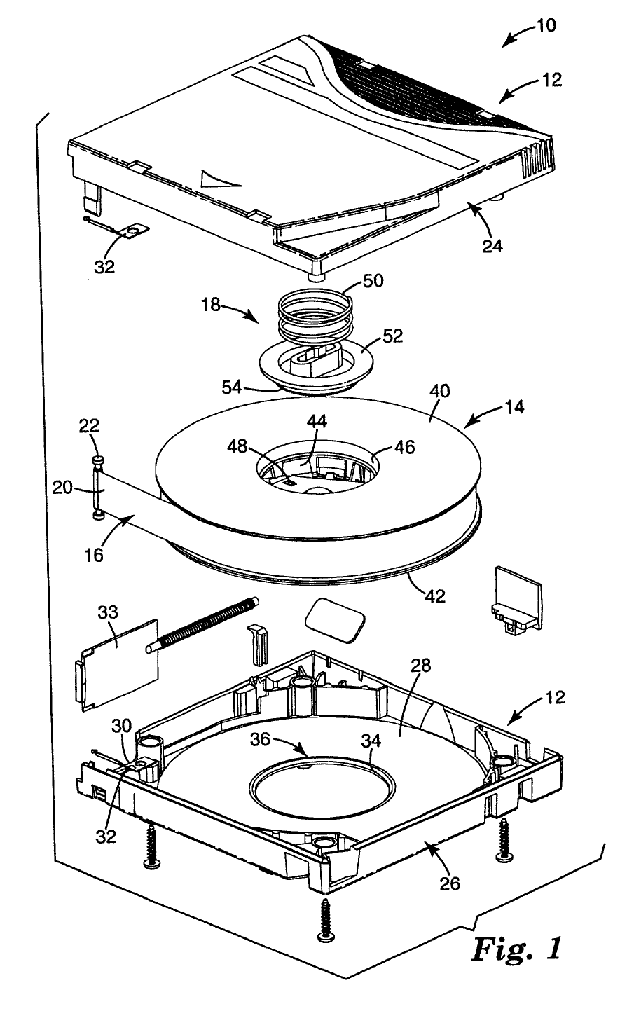

One preferred embodiment of a data storage tape cartridge 10 is shown in FIG. 1. Generally speaking, the data storage tape cartridge 10 includes a housing 12, at least one tape reel assembly 14, a storage tape 16, and a brake assembly 18. The tape reel assembly 14 is rotatably disposed within the housing 12. The storage tape 16, in turn, is wound about a portion of the tape reel assembly 14 and includes a free-end 20 attached to a pin 22. Finally, the brake assembly 18 is centrally positioned within a portion of the tape reel assembly 14 and is connected to a portion (not shown) of the housing 12.

The housing 12 is sized in accordance with industry-accepted tape drive form factors, and is preferably generally square. Alternatively, other shapes such as rectangular are equally acceptable. The housing 12 is defined by a first housing section 24 and a second housing section 26. In one preferred embodiment, the first housing section 24 provides a cover, whereas the second housing section 26 serves as a base. It should be understood that as used throughout this specification, directional terminology, such as “cover,” “base,” “upper,” “lower,” “top,” “bottom,” etc., are used for purposes of illustration only, and are in no way limiting.

The first and second housing sections 24 and 26 are configured to be reciprocally mated to one another to define an enclosed space 28 (shown generally in FIG. 1) for maintaining various other components of the data storage tape cartridge 10. For example, the housing 12 forms an exit window 30 that, in conjunction with a pin retention device 32, is configured to hold the pin 22 and serves as an opening for the storage tape 16 to exit from the enclosed space 28. Upon opening of a door mechanism 33, the storage tape 16 can be threaded to a tape drive (not shown) when the pin 22 is removed from the exit window 30. Conversely, when the pin 22 is fastened to the retention device 32 and the door mechanisms 33 is closed, the exit window 30 is covered.

In addition to the exit window 30, the second housing section 26 further forms a tape reel opening 34 and a centering feature 36 (shown generally in FIG. 1). The tape reel opening 34 provides access to the enclosed space 28, and in particular, the tape reel assembly 14, by a drive chuck portion of a tape drive (not shown). The centering feature 36 is described in greater detail below in conjunction with a corresponding portion of the tape reel assembly 14. In general terms, however, the centering feature 36 supports the tape reel assembly 14 in a centered position relative to the tape reel opening 34.

The first housing section 24 includes a connector (not shown) extending from an inner surface thereof. The connector is positioned opposite the tape reel opening 34 and is configured to retain a portion of the brake assembly 18. As is known to those of ordinary skill in the art, in one preferred embodiment, the connector is a post sized to slidably receive a portion of the brake assembly 18. Alternatively, the connector may assume other forms known in the art, such as a series of teeth.

The pin 22 is a well known component, preferably assuming a dumbbell shape. The pin 22 is sized to be selectively engaged by the pin retention device 32, as well as by an automatic threading apparatus of a tape drive (not shown). Alternatively, the pin 22 can be a leader block, as known in the art. Even further, depending upon a desired configuration of the data storage tape cartridge 10, the pin 22 may be eliminated, such as with a dual tape reel design.

The tape reel assembly 14 is described in greater detail below, and generally includes an upper flange 40, a lower flange 42 and a hub body 44 (partially hidden in FIG. 1). The storage tape 16 is wound about a tape-winding surface (not shown) of the hub body 44 constrained laterally by the flanges 40, 42. Further, the tape reel assembly 14 defines a central opening 46 sized to receive the brake assembly 18. Brake teeth 48 are formed within the hub 44 and are sized to selectively engage a corresponding portion of the brake assembly 18, as described below. Further, although not shown, the tape reel assembly forms drive teeth extending axially outwardly relative to the lower flange 42 for engagement by a tape drive chuck (not shown). Upon final assembly, the central opening 46 is axially aligned with the tape reel opening 34 in the housing 12.

The storage tape 16 is preferably a magnetic tape of a type commonly known in the art. For example, the storage tape 16 can consist of a balanced polyethylene naphthalate (PEN) based material coated on one side with a layer of magnetic material dispersed within a suitable binder system, and on the other side with a conductive material dispersed within a suitable binder system. Acceptable magnetic tape is available, for example, from Imation Corp. of Oakdale, Minn.

The brake assembly 18 is of a type known in the art and preferably consists of a spring 50 and a brake body 52. The spring 50 is preferably a coil spring formed to bias the brake body 52 within the central opening 46 of the tape reel assembly 14. In this regard, the brake body 52 preferably includes a toothed surface 54 configured to engage a corresponding portion of the tape reel assembly 14 in a “locked” state.

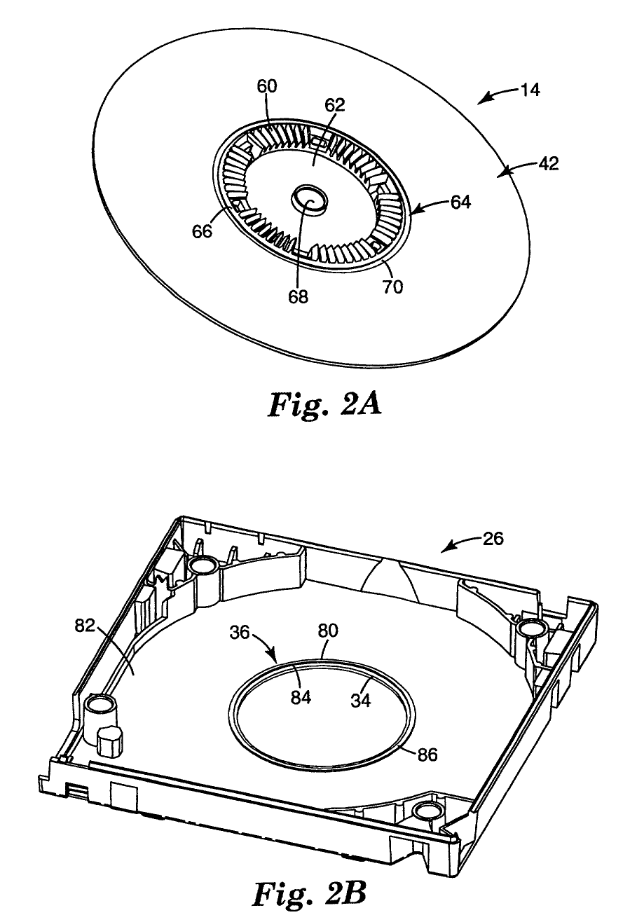

The data storage tape cartridge 10 is uniquely configured to axially align and support the tape reel assembly 14 relative to the tape reel opening 34 via the centering feature 36 and a corresponding portion of the tape reel assembly 14. One preferred technique for effectuating this interaction is illustrated in FIGS. 2A and 2B. As a point of reference, FIG. 2A depicts a bottom perspective view of one preferred embodiment of the tape reel assembly 14, including the lower flange 42. The hub body 44 is hidden in FIG. 2A and the upper flange 40 has been omitted from the view of FIG. 2A for purposes of illustration. Conversely, FIG. 2B illustrates one preferred embodiment of the base 26, including the centering feature 36 corresponding with the tape reel assembly 14 illustrated in FIG. 2A.

With specific reference to FIG. 2A, the tape reel assembly 14 includes the lower flange 42, drive teeth 60, a center area 62, and a centering device 64. As known in the art, the drive teeth 60 extend outwardly in a generally axial fashion (relative to the hub 44 of FIG. 1), and are configured to be engaged by corresponding teeth of a tape drive chuck (not shown). The drive teeth 60 can assume a variety of forms other than that shown in FIG. 2A but are typically arranged in a circular fashion. For example, the drive teeth 60 can be something other than intermittently spaced teeth (e.g., a continuous ring of teeth). As described below, in one preferred embodiment, the drive teeth 60 are formed by the lower flange 42 component that, in turn, is secured to the upper flange 40 (FIG. 1) about the hub 44 (FIG. 1). Other constructions are equally acceptable. For example, the hub 44 can form the drive teeth 60, with the lower flange 42 defining a passage for accessing the drive teeth 60. Alternatively, the upper flange 40 can form the drive teeth 60 as protrusions through corresponding apertures in the lower flange 42. Regardless, in one preferred embodiment, an outer edge 66 of the drive teeth 60 is tapered for reasons described below.

The center area 62 is preferably defined within an inner diameter of the drive teeth 60 and is preferably sized to receive a magnetic piece (not shown). As is known in the art, the magnetic piece facilitates engagement between the tape reel assembly 14 and a tape drive chuck during use thereof. Further, a central bore 68 is formed within the center area 62. The bore 68 allows the tape drive chuck (not shown) to disengage the brake assembly 18 (FIG. 1).

Finally, in the one preferred embodiment of FIG. 2A, the centering device 64 is a continuous groove 70. The groove 70 forms a circle and extends axially inwardly from an outer surface 72 of the lower flange 42. The groove 70 defines a diameter greater than an outer diameter defined by the drive teeth 60. Thus, the groove 70 is radially spaced from, or outside of, the drive teeth 60.

With additional reference to FIG. 2B, the centering feature 36 associated with the base 26 is a rib 80 corresponding in size and shape with the groove 70 formed by the lower flange 42. More particularly, with the one preferred embodiment of FIG. 2B, the rib 80 extends axially from an inner surface 82 of the base 26, and forms a continuous circle having a diameter corresponding with a diameter of the groove 70. For example, in one preferred embodiment, the rib 80 and the groove 70 define substantially identical inner diameters. The circle defined by the rib 80 is coaxially aligned with a center point of the tape reel opening 34. Further, the circle defined by the rib 80 has a diameter greater than a diameter of the tape reel opening 34 at the inner surface 82. That is to say, the rib 80 is radially spaced from, or outside of, the tape reel opening 34. In one preferred embodiment, the rib 80 includes an inner wall 84 and an outer wall 86. The inner and outer walls 84, 86 may extend in an axial fashion relative to the tape reel opening 34 (i.e., perpendicular to a plane of the inner surface 82), or they may be other mating shapes, such as triangular, rounded, etc.

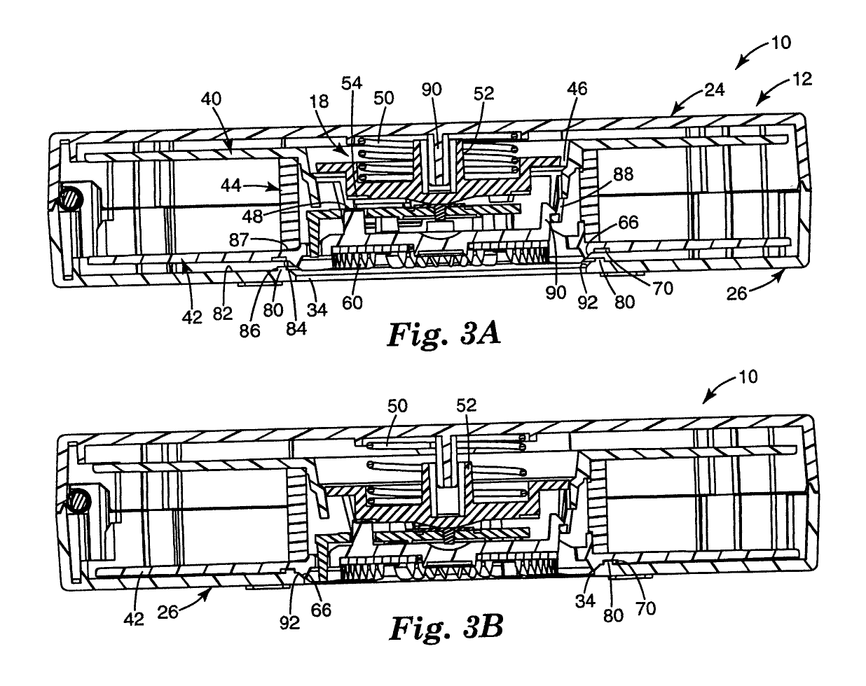

FIGS. 3A and 3B illustrate interaction between the groove 70 and the rib 80 upon final assembly of the data storage tape cartridge 10. In particular, FIG. 3A illustrates the data storage tape cartridge 10 in an “unlocked” state, whereby the tape reel assembly 14 has been engaged by a tape drive chuck (not shown). Conversely, FIG. 3B illustrates the data storage tape cartridge 10 in a “locked” state, such as when the data storage tape cartridge 10 is not in use.

As a point of clarification, FIGS. 3A and 3B depict one preferred embodiment of the tape reel assembly 14 in greater detail. Once again, the tape reel assembly includes the upper flange 40, the lower flange 42, the hub 44, the brake teeth 48, the drive teeth 60, and the groove 70. The lower flange 42 component forms both of the brake teeth 48 and the drive teeth 60, with the brake teeth 48 extending axially inwardly relative to a bottom end 87 of the hub 44, and the drive teeth 60 extending axially outwardly relative to the bottom end 87 of the hub 44. Further, the upper flange 40 forms a plurality of loop members 88 (one of which is shown in FIGS. 3A and 3B), whereas the lower flange 42 forms a plurality of corresponding legs 90 (one of which is depicted in FIGS. 3A and 3B). The upper and lower flanges 40, 42 are assembled to one another via engagement of the respective loop members 88 and legs 90 within the hub 42. Alternatively, a wide variety of other constructions/assembly techniques are available for the tape reel assembly 14, as known in the art. Regardless, the groove 70 is formed to define a diameter greater than an outer diameter of both the brake teeth 48 and the drive teeth 60, such that the groove 70 is radially spaced from the brake teeth 48 and the drive teeth 60.

With specific reference to the unlocked state of FIG. 3A, the brake assembly 18, and in particular the brake body 52, is shown as being slidably secured to a post 90 formed by the cover 24 of the housing 12. The brake body 52 is further coaxially disposed within the central opening 46 of the tape reel assembly 14. Finally, in one preferred embodiment, most clearly shown in FIG. 3A, the base 26 forms a chamfered surface 92 at the tape reel opening 34. In the unlocked state, a bias of the spring 50 against the brake body 52 has been overcome (such as via engagement with a tape drive chuck (not shown)). As a result, the toothed surface 54 of the brake body 52 is disengaged from the brake teeth 48 of the tape reel assembly 14 and the rib 80 is disengaged from the groove 70. In this unlocked state, then, the tape reel assembly 14 is free to be driven in a rotary fashion via the tape drive chuck.

Conversely, in FIG. 3B, the spring 50 biases the brake body 52 against the tape reel assembly 14 such that the lower flange 42 is forced downwardly (relative to the orientation of FIG. 3B) toward the base 26. In this regard, as the tape reel assembly 14 is transitioned from the unlocked state of FIG. 3A to the locked state of FIG. 3B, the tapered, outer edge 66 of the drive teeth 60 contacts the chamfered surface 92 formed by the base 26 to generally guide the tape reel assembly 14 to a coaxially aligned position relative to the tape reel opening 34. Further, the groove 70 engages the rib 80, with the groove 70 being configured to at least partially contact at least one of the inner and outer walls 84, 86 (best shown in FIG. 3A) defined by the rib 80. For example, in the one preferred embodiment of FIG. 3B, the inner wall 84 contacts a wall defining the groove 70, whereas a slight clearance is generated between the outer wall 86 and an opposing wall defining the groove 70 to facilitate subsequent disengagement of the components 70, 80. With this configuration, then, interaction between the rib 80 and the groove 70 prevents the tape reel assembly 14 from being laterally displaced relative to the tape reel opening 34 should the data storage tape cartridge 10 be moved or rotated from the horizontal orientation of FIG. 3B. Once again, and as best illustrated by FIGS. 3A and 3B, both the groove 70 and the rib 80 define identical diameters that are greater than a diameter defined by the tape reel opening 34 at the inner surface 82 of the base 26.

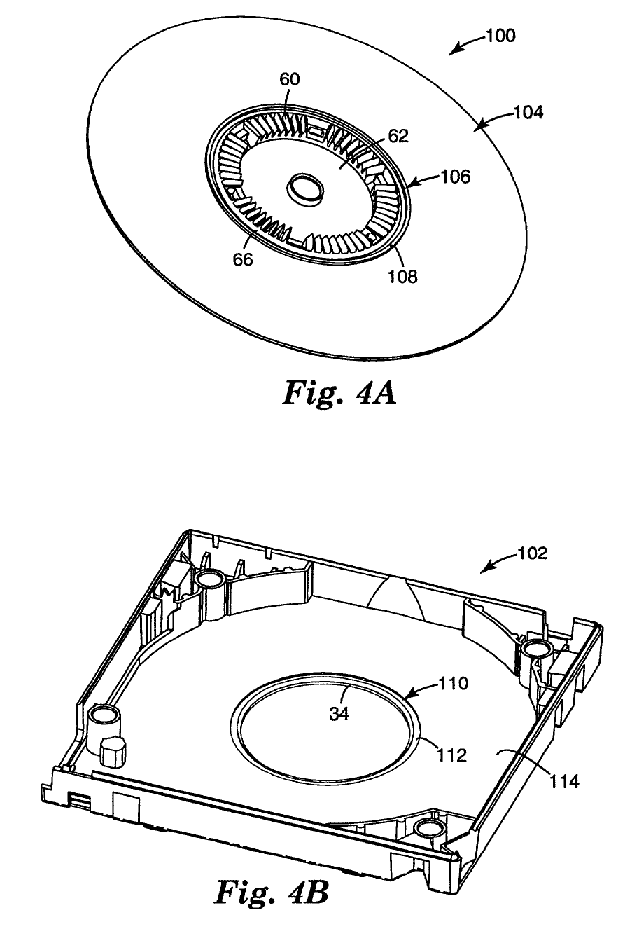

An alternative embodiment tape reel assembly 100 and base 102 are illustrated in FIGS. 4A and 4B, respectively. Once again, for purposes of illustration only, a portion of the tape reel assembly 100 is shown. With this in mind, the tape reel assembly 100 is highly similar to the tape reel assembly 14 (FIG. 2A) previously described, with like elements being identically identified. The tape reel assembly 100 includes a lower flange 104, the drive teeth 60, the center area 62, and a centering device 106. In the embodiment of FIG. 4A, the centering device 106 is formed as a continuous, circular rib 108. Conversely, the base 102 includes a corresponding centering feature 110 in the form of a groove 112. The groove 112 is an inward impression relative to an inner surface 114 of the base 102 and defines a diameter greater than a diameter of the tape reel opening 34.

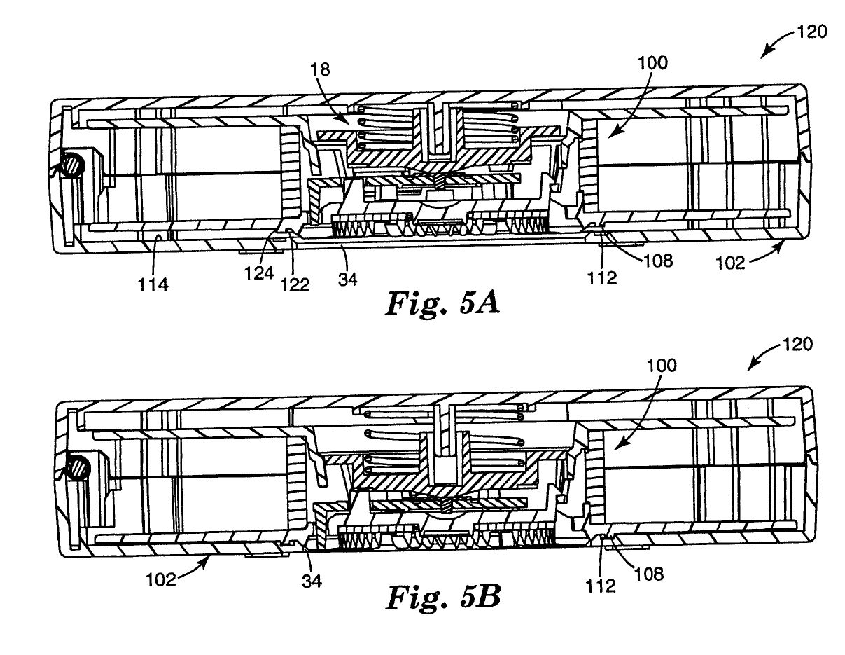

An alternative embodiment data storage tape cartridge 120, including the tape reel assembly 100 on the base 102 is provided in FIGS. 5A and 5B. As a point of reference, the data storage tape cartridge 120 is highly similar to the data storage tape cartridge 10 previously described and is shown in an unlocked state in FIG. 5A and a locked state in FIG. 5B. With this in mind, FIG. 5A illustrates the rib 108 as being defined by an inner axial wall 122 and an outer axial wall 124 in transverse cross-section. The groove 112 is configured to receive and contact both of the inner and outer axial walls 122, 124. Further, the rib 108 and the groove 112 define a diameter greater than, and thus are radially spaced from, the tape reel opening 34 at the inner surface 114 of the base 102. Along these same lines, the rib 108 is radially spaced from the drive teeth 60 and the brake teeth 48 formed by the tape reel assembly 100.

As the tape reel assembly 100 is transitioned from the unlocked state (FIG. 5A) to the locked state (FIG. 5B) via the brake assembly 18, the edge 66 of the drive teeth 60 contacts the chamfered surface 92 of the base 102 to axially align the tape reel assembly 100 relative to the tape reel opening 34. Further, the rib 108 engages the groove 112. In this regard, the groove 112 supports the rib 108 along at least one of the inner and outer axial walls 122, 124 such that the lower flange 104, and thus the tape reel assembly 100, will not laterally move or shift relative to the tape reel opening 34 when the data storage tape cartridge 120 is moved or rotated from the horizontal orientation of FIGS. 5A and 5B. For example, in one preferred embodiment, outer wall 124 contacts an outer wall defining the groove 112, and a slight clearance is generated between the inner wall 122 and an opposing wall defining the groove 112. Alternatively, the groove 112 can be configured to contact both of the walls 122, 124.

The data storage tape cartridge and associated tape reel assembly of the present invention provides a marked improvement over previous designs. In particular, the housing and the at least one tape reel assembly are provided with corresponding centering features in the form of a rib and receiving groove. The centering features are configured and positioned relative to a tape reel opening formed in the base portion of the housing so as to prevent the tape reel assembly from becoming laterally displaced during handling and/or storage operations. In one embodiment, the rib is formed by the housing and the groove is formed by the lower flange of the tape reel assembly. In an alternative embodiment, the lower flange forms the rib, whereas the housing forms the groove.

Although the present invention has been described with respect to preferred embodiments, workers skilled in the art will recognize that changes can be made in form and detail without departing from the spirit and scope of the present invention. For example, the data storage tape cartridge has been described with reference to a single-reel design. Alternatively, the disclosed embodiments can be incorporated into a dual-reel data storage tape cartridge.

What is claimed is:

1. A data storage tape cartridge comprising:
a housing including a base and a cover combining to define an enclosed space, the base forming a tape reel opening;
a tape reel assembly comprising:
a hub defining a tape-winding surface,
opposing upper and lower flanges extending radially from opposite ends of the hub, respectively,
drive teeth extending in an axial fashion relative to the hub,
wherein the tape reel assembly is disposed within the housing such that the drive teeth are accessible through the tape reel opening;
a brake assembly including a spring biasing a brake body to a locked state in which the brake body impedes rotation of the tape reel assembly;
a centering device for supporting the tape reel assembly in a centered position relative to the tape reel opening in the locked state, the centering device including:
a rib formed by one of the lower flanges and the base,
a groove configured to selectively receive the rib, the groove being formed by another of the lower flanges and the base; and
a storage tape wound about the tape-winding surface of the hub.

2. The data storage tape cartridge of claim 1, wherein the centering device is configured to prevent lateral displacement of the tape reel assembly relative to the housing in the locked state when the data storage tape cartridge is vertically oriented.

3. The data storage tape cartridge of claim 1, wherein the rib and the groove are continuous.

4. The data storage tape cartridge of claim 1, wherein the rib and the groove define circles of identical diameters.

5. The data storage tape cartridge of claim 1, wherein the rib and the groove are configured such that in the locked state the rib and groove are coaxially arranged relative to a center of the tape reel opening.

6. The data storage tape cartridge of claim 1, wherein the tape reel opening defines a diameter, and further wherein each of the groove and the rib defines a diameter greater than a diameter of the tape reel opening.

7. The data storage tape cartridge of claim 1, wherein the groove is defined by inner and outer axial walls in transverse cross-section.

8. The data storage tape cartridge of claim 1, wherein the rib is formed by the lower flange and the groove is formed by the base.

9. The data storage tape cartridge of claim 8, wherein the groove is defined in an inner surface of the base.

10. The data storage tape cartridge of claim 9, wherein the groove is radially spaced from the tape reel opening at the inner surface of the base.

11. The data storage tape cartridge of claim 1, wherein the rib is formed by the base and the groove is formed by the lower flange.

12. The data storage tape cartridge of claim 11, wherein the rib extends axially from an inner surface of the base.

13. The data storage tape cartridge of claim 12, wherein the rib is radially spaced from the tape reel opening at the inner surface of the base.

14. A tape reel assembly for use with a data storage tape cartridge, the tape reel assembly comprising:
a hub defining a tape-winding surface, a top end and a bottom end;
drive teeth extending axially outwardly relative to the bottom end of the hub;
brake teeth extending axially inwardly relative to the bottom end of the hub;
an upper flange extending radially from the top end of the hub; and
a lower flange extending radially from the bottom end of the hub, the lower flange defining an outer surface and an inner surface, and further forming a centering device that is radially spaced from the drive teeth and the brake teeth.

15. The tape reel assembly of claim 14, wherein the centering device is a rib.

16. The tape reel assembly of claim 14, wherein the centering device is a groove.

17. The tape reel assembly of claim 16, wherein the groove is defined by opposing walls in transverse cross-section.

18. A method of supporting a tape reel assembly in a centered position relative to a tape reel opening in a housing of a data storage tape cartridge, the method comprising:
providing the tape reel assembly with a first centering feature;
providing the housing with a second centering feature, the second centering feature being formed interiorly relative to the housing about, and spaced from, the tape reel opening;
wherein one of the first and second centering features is a rib and another of the first and second centering features is a groove;
biasing the tape reel assembly to a locked state whereby the first centering feature engages the second centering feature;
wherein upon articulation of the data storage tape cartridge from a horizontal orientation, the centering feature prevents lateral displacement of the tape reel assembly relative to the tape reel opening in the locked state.

19. The method of claim 18, wherein the first centering feature is a rib and the second centering feature is a corresponding groove.

20. The method of claim 18, wherein the first centering feature is a groove and the second centering feature is a corresponding rib.
